(19) United States
(12) Patent Application Publication
(10) Pub. No.: US 2026/0220350 A1
(43) Pub. Date: Jul. 30, 2026

(54) ADAPTING DESIGN CONSTRAINTS FOR STATIC TIMING ANALYSIS OF A CIRCUIT

(71) Applicant: International Business Machines Corporation, Armonk, NY (US)

(72) Inventors: Jack DiLullo, Austin, TX (US); Eric Foreman, Fairfax, VT (US); Manish Verma, Bangalore (IN)

(21) Appl. No.: 19/039,919

(22) Filed: Jan. 29, 2025

(51) Int. Cl. G06F 30/398; G01R 31/28; G06F 30/27; G06F 30/392; G06F 111/04; G06F 111/08; G06F 119/12

(52) U.S. Cl. CPC G06F 30/398; G01R 31/2882; G06F 30/27; G06F 30/392; G06F 2111/04; G06F 2111/08; G06F 2119/12

(57) ABSTRACT

Examples described herein provide a computer-implemented method for adapting design constraints for static timing analysis of a circuit. The method includes receiving a set of prior constraints associated with a prior clock schema for the circuit. The method further includes receiving an indication of a desired clock schema for the circuit. The method further includes receiving transformation specifications for the circuit and a design topology for the circuit. The method further includes analyzing the set of prior constraints, the prior clock schema, the desired clock schema, the transformation specifications, and the design topology to determine a set of new constraints for the desired clock schema for the circuit. The method further includes causing the circuit to be fabricated based at least in part on the set of new constraints for the desired clock schema for the circuit.

### BACKGROUND

The present disclosure relates to computing environments, and more specifically, to adapting design constraints for static timing analysis of a circuit.

Circuits can experience failures because of design or manufacturing defects. It is useful to predict when such failures may occur. Circuit design analysis techniques can be used to predict circuit failures, enabling the circuits to be assessed for reliability and performance under various conditions.

### SUMMARY

According to an embodiment, a computer-implemented method for adapting design constraints for static timing analysis of a circuit is provided. The method includes receiving a set of prior constraints associated with a prior clock schema for the circuit. The method further includes receiving an indication of a desired clock schema for the circuit. The method further includes receiving transformation specifications for the circuit and a design topology for the circuit. The method further includes analyzing the set of prior constraints, the prior clock schema, the desired clock schema, the transformation specifications, and the design topology to determine a set of new constraints for the desired clock schema for the circuit. The method further includes causing the circuit to be fabricated based at least in part on the set of new constraints for the desired clock schema for the circuit.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment having a design constraints adaptation engine according to an embodiment;

FIG. 2 illustrates a block diagram of the design constraints adaptation engine of FIG. 1 according to an embodiment;

FIG. 3 illustrates a block diagram of a portion of a circuit according to an embodiment;

FIG. 4A illustrates a table of input constraints according to an embodiment;

FIG. 4B illustrates a table of output constraints according to an embodiment;

FIG. 5 illustrates a clock signal according to an embodiment;

FIG. 6 illustrates a diagram of a scenario for different cycle timing according to an embodiment;

FIG. 7 illustrates a diagram of a scenario for different leading edge timing according to an embodiment;

FIG. 8 illustrates a diagram of a scenario for different cycle and leading edge timing according to an embodiment;

FIGS. 9A and 9B illustrate a diagrams of a scenario for multiple interacting clocks according to an embodiment;

FIG. 10 illustrates a diagram of for a scenario multiple non-interacting clocks according to an embodiment;

FIG. 11 illustrates a flow diagram of a method for adapting design constraints for static timing analysis of a circuit according to an embodiment;

FIGS. 12A, 12B, 12C, 12D, and 12E illustrate examples of tables of constraints for static timing analysis of a circuit according to various embodiments;

FIG. 13 illustrates a block diagram of a system to perform circuit design optimization according to one or more embodiments;

FIG. 14 illustrates a flow diagram of a method of fabricating an integrated circuit according to one or more embodiments; and

FIG. 15 illustrates a flow diagram of a method for adapting design constraints for static timing analysis of a circuit according to an embodiment.

### DETAILED DESCRIPTION

One or more embodiments described herein provide for adapting design constraints for static timing analysis of a circuit.

Circuit design analysis involves evaluating the performance and functionality of electronic circuits. One component of circuit design analysis is static timing analysis (STA), which analyzes whether a circuit design satisfies desired speed requirements for the circuit design by verifying that signals propagate through the circuit within acceptable time limits. Two approaches to STA are deterministic timing analysis and static timing analysis.

Deterministic timing analysis uses fixed values for delays and other parameters to provide a worst-case scenario evaluation. This approach assumes that the elements of the circuit, such as gates and wires, have constant, predefined delays. The deterministic timing analysis calculates the longest path that a signal might take through the circuit (known as the “critical path”) to ensure the circuit design meets the desired clock period.

Statistical timing analysis (also referred to as “statistical static timing analysis” or “SSTA”) accounts for variations in process, voltage, and temperature (PVT) by using probability distributions instead of fixed values as in determining timing analysis. This approach models delays as random variables and uses statistical methods to estimate the probability of timing violations. Statistical timing analysis provides a distribution of potential timing outcomes, rather than a single worst-case scenario.

Design constraints play a significant role in the development and analysis of integrated circuits. These constraints ensure that the circuit operates correctly under various conditions by specifying the timing requirements for signals within the circuit. STA is a widely used technique to verify that these timing constraints are met, ensuring the circuit's performance and reliability. However, the process of creating and adapting design constraints for new chip (also referred to as “circuit”) designs is often tedious, time-consuming, and prone to error. This is particularly challenging when transitioning between different clocking schemas or adapting to new PVT conditions.

Existing approaches to adapting design constraints typically involve manual adjustments by chip designers. These approaches rely on the iterative process of implementing previous design constraints, running timing analysis, and modifying/adapting the constraints based on the results. This manual approach is not only labor-intensive but also susceptible to errors and inefficiencies, which can lead to suboptimal performance or even functional failures in the final circuit design. Additionally, existing approaches do not adequately address the complexities introduced by modern clocking techniques, such as dual-edge clocking, or the need to adapt constraints across different PVT corners.

One or more embodiments described herein address these and other shortcomings by providing a way to automatically adapt existing design constraints into new circuit designs. According to an embodiment, this involves analyzing prior constraints for a prior clock schema of the prior circuit design, analyzing a new (desired) clock schema, analyzing transformation specifications and design topology, and adapting the prior constraints for the prior clock schema as needed based on the results. In this way, constraints for a prior clock schema can be adapted to a new (desired) clock schema. According to one or more embodiments, the transformation process includes converting single-edge clocking circuits to dual-edge clocking circuits, adapting constraints for different PVT sensors, and/or the like, including combinations and/or multiples thereof. By automating the constraint transformation process, one or more embodiments reduces the potential for error, improves efficiency, and ensures that the new design constraints are optimized for the specific requirements of the new circuit design and/or clock schema.

One or more embodiments provides for analyzing the netlist for clock, data, and scan topology of a circuit, receives both the old and new clock schemas along with transformation specifications, and verifies the original constraints against the clocking schema. One or more embodiments then performs a shift and/or scale of constraints based on this information and generates new constraints for the current operation.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

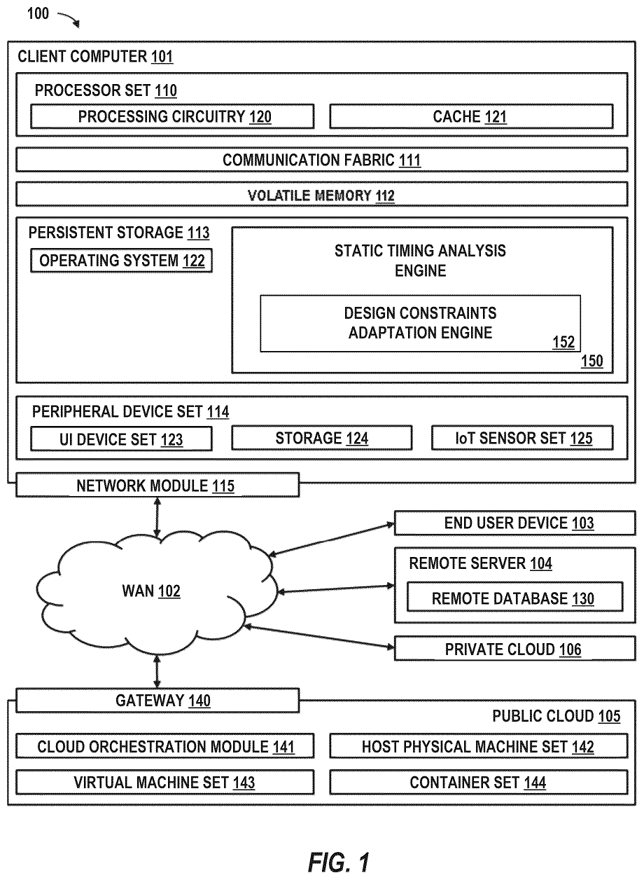

FIG. 1 illustrates a computing environment 100, according to an embodiment. Computing environment 100 contains an example of an environment for the execution of at least some of the computer code involved in performing the inventive methods, such as a static timing analysis engine 150 for generating parameters for static timing analysis of a circuit. The static timing analysis engine 150 can include a design constraints adaptation engine 152. In addition to the static timing analysis engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the static timing analysis engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the static timing analysis engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the static timing analysis engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

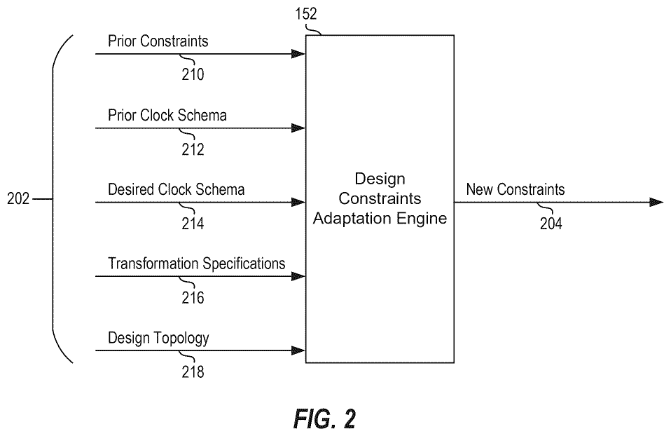

According to one or more embodiments, the design constraints adaptation engine 152 is responsible for processing various inputs to generate new, optimized design constraints that meet the requirements of the new chip design and the desired clock schema. The design constraints adaptation engine 152 is now described in more detail with reference to FIG. 2. In particular, FIG. 2 illustrates a block diagram of the design constraints adaptation engine 152 of FIG. 1 according to an embodiment. FIG. 2 shows the inputs 202 to and output (e.g., new constraints 204) of the design constraints adaptation engine 152.

The inputs 202 to the design constraints adaptation engine 152 include one or more of prior constraints 210, prior clock schema 212, desired clock schema 214, transformation specifications 216, and design topology 218. The prior constraints 210 represent the existing design constraints for a prior chip design. The prior clock schema 212 represents the clock schema used in the prior chip design. The desired clock schema 214 represents the new (desired) clock schema that the new chip design will use. The transformation specifications 216 define how the design constraints should be transformed to fit the new clock schema defined by the prior clock schema 212. The design topology 218 represents the layout and structure of the chip design, including the arrangement of components and interconnections.

The design constraints adaptation engine 152 processes these inputs 202 to generate new constraints 204, which are adaptations of the prior constraints 210, to meet the requirements of the new chip design defined by the desired clock schema 214. The new constraints 204 are then output from the design constraints adaptation engine 152 for use in fabricating the new chip design.

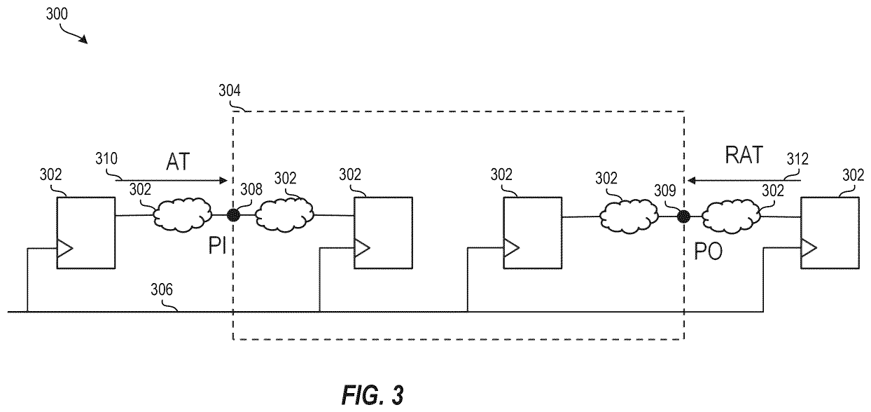

FIG. 3 illustrates a block diagram of a portion of a circuit 300 according to an embodiment. FIG. 3 highlighting the flow of data and the timing constraints within the circuit 300. The circuit 300 includes components 302, such as flip-flops, which are sequential logic elements used to store and transfer data. The components 302 within a boundary 304 represent a portion of the circuit 300 that is being subjected to timing analysis. The boundary 304 supports a hierarchical design methodology that enables partitioning the circuit 300 into smaller portions, which may be referred to as “macros.” Macros are designed and timed independent of the context, referred to as “out-of-context” (OOC) analysis. The OOC analysis uses the arrival time and slew (transition time) of the signal at the PI 308 (represented by AT 310), uses the required arrival time of the signal at the PO 309 (represented by RAT 312), is used for both rise and fall transitions, and is used for late and early modes.

The components 302 are electrically connected via a clock path 306, which represents the path through which the data signal travels within the circuit 300. A primary input (PI) 308 defines a point where an input signal enters the portion of the circuit 300 defined by the boundary 304, and a primary output (PO) 309 defines a point where the output signal exits the portion of the circuit 300 defined by the boundary 304. An arrival time (AT) 310 is the time at which the input signal arrives at the primary input 308, while the required arrival time (RAT) 312 is the time by which the output signal is specified to arrive at the primary output 309 to meet specified timing requirements.

The boundary 304 supports a hierarchical design methodology that enables partitioning the circuit 300 into smaller portions, which may be referred to as “macros.”

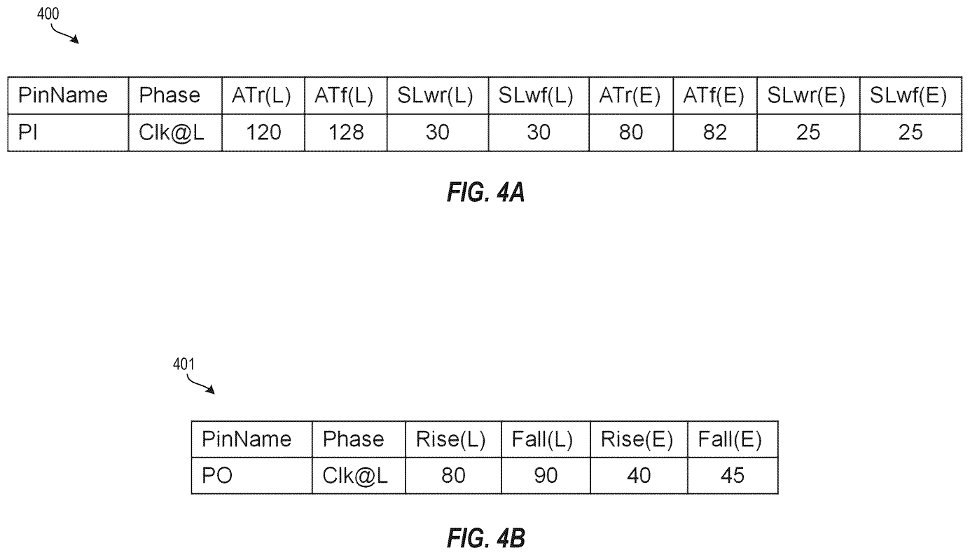

FIG. 4A illustrates a table 400 of input constraints according to an embodiment. The table 400 provides detailed information about the timing constraints at the PI 308 of the circuit 300. The columns in the table include the pin name (PinName), phase (Phase), arrival time for rise late mode (ATr(L)) arrival time for fall late mode (ATf(L)), slew for rise late mode (SLwr(L)), slew for fall late mode (SLwf(L)), arrival time for rise early mode (ATr(E)), arrival time for fall early mode (ATf(E)), slew for rise early mode (SLwr(E)), slew for fall early mode (SLwf(E)).

Specifically, the table 400 shows that for the PI 308 with a clock phase of Clk@L, the arrival times are 120 and 128 for the rise and fall edges in late mode, respectively, and 80 and 82 for the rise and fall edges in early mode, respectively. The slew values are 30 for both rise and fall edges in late mode, and 25 for both rise and fall edges in early mode. The table 400 defines the input signal characteristics used for timing analysis of boundary paths, from a PI 308 to the first sequential element (e.g., component 302, which may be a flip-flop).

FIG. 4B illustrates a table 401 of output constraints according to an embodiment. The table 401 provides detailed information about the timing constraints at the PO 309 of the circuit 300. The columns in the table include the pin name (PinName), phase (Phase), and the required arrival times for rise and fall edges in both late mode (L) and early mode (E). Specifically, the table shows that for the primary output PO with a clock phase of Clk@L, the required arrival times are 80 for the rise edge and 90 for the fall edge in late mode, and 40 for the rise edge and 45 for the fall edge in early mode. The table 401 is useful for defining the output constraints desired to be met in timing analysis to ensure proper circuit operation, ensuring that the signal arrives at the primary output 309 within the specified timing requirements.

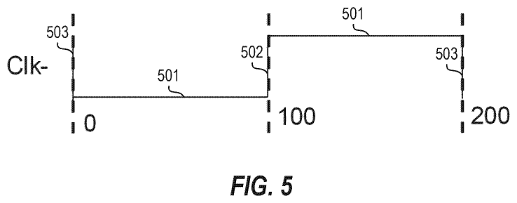

FIG. 5 illustrates a clock signal 501 according to an embodiment. The diagram depicts the waveform of the clock signal 501, showing its periodic nature with distinct rising edges (e.g., edge 502) and falling edges (e.g., edge 503). Waveform in the diagram is labelled as Clk−. A minus sign indicates falling edge (e.g., edge 503) is the leading edge and the rising edge (e.g., edge 502) is the trailing edge. Similarly, a clock can also be represented as Clk+ where rising edge is the leading edge and falling edge is the trailing edge. The clock signal 501 is characterized by its cycle time, which is the duration of one complete cycle of the waveform, including both the high and low states. The rising edge (e.g., edge 502) of the clock signal is the transition from low to high, while the falling edge (e.g., edge 503) is the transition from high to low. Clock signals, such as the clock signal 501, are fundamental to the operation of synchronous circuits, as they dictate the timing for data transfer and synchronization across various components within circuits. The precise timing of the leading and trailing edges is used to ensure that data is correctly captured and propagated through the circuit, making the clock signal 501 a useful element in the design and analysis of integrated circuits. In the example of FIG. 5, the clock signal 501 has a leading edge value of “0,” a trailing edge value of “100,” and a cycle time of “200.”

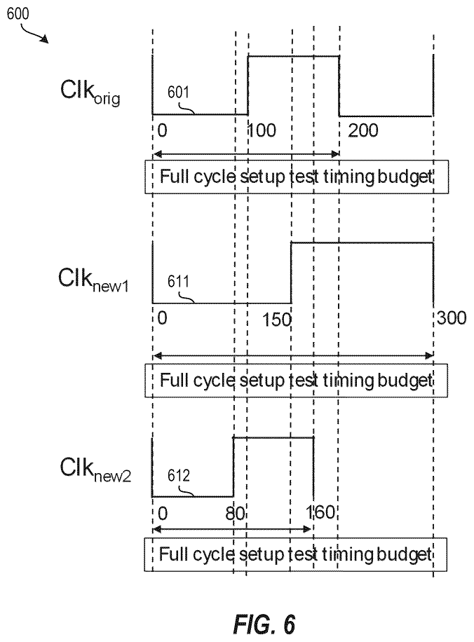

FIG. 6 illustrates a diagram of a scenario 600 where cycle time of the clock signal in prior clock schema and desired clock schema are different but their leading edges are still aligned according to an embodiment. The scenario 600 demonstrates the transformation of clock signals when adapting design constraints for different cycle times. FIG. 6 shows three clock signals: clock signal 601 for Clk_{orig}, clock signal 611 for Clk_{new1}, and clock signal 612 for Clk_{new2}. The scenario 600 involves scaling the cycle time of the clock. Clk_{orig} has a cycle time of 200 units, Clk_{new1} has a cycle time of 300 units, and Clk_{new2} has a cycle time of 160 units. Clk_{orig} has a leading edge at 0 units and a trailing edge at 100 units, Clk_{new1} has a leading edge at 0 units and a trailing edge at 150 units, and Clk_{new2} has a leading edge at 0 units and a trailing edge at 80 units. The transformation process adjusts the timing quantities, such as arrival time, required arrival time, and slew, by the ratio of the new cycle time to the original cycle time. For example, a new timing quantity can be calculated according to the following equation:

$$New Timing Quantity = Orig Timing Quantity * \frac{New cycle time}{Orig cycle time}$$

where new timing quantity is the adjusted timing value for the desired clock schema 214, orig timing quantity is the original timing value for the prior clock schema 212, new cycle time is the cycle time for the new clock of the desired clock schema 214, and orig cycle time is the cycle time of the clock in the prior clock schema 212. This scaling ensures that the full cycle setup test timing budget is appropriately adjusted to accommodate the changes in cycle time, maintaining the integrity of the timing analysis and ensuring that the circuit operates correctly under the new clock schema. The figure visually represents how the full cycle setup test timing budget is recalibrated for each new clock signal, highlighting the usefulness of accurate constraint transformation in adapting to different clocking environments.

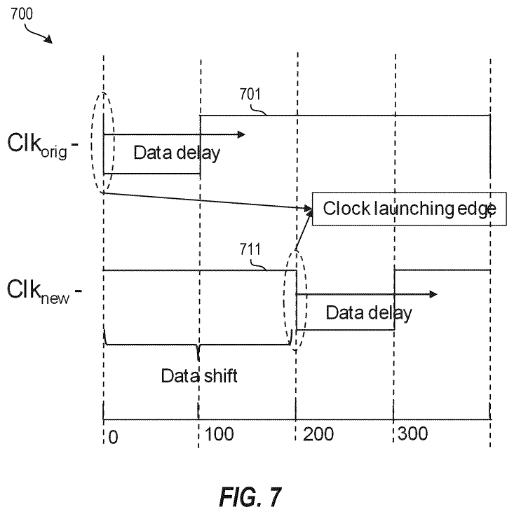

FIG. 7 illustrates a diagram of a scenario 700 for different leading edge time with the same cycle time according to an embodiment. The scenario 700 addresses the transformation of clock signals when there is a difference in the leading edge timing without altering the cycle time. FIG. 7 depicts two clock signals: clock signal 701 for Clk_{orig} and clock signal 711 for Clk_{new}. Clk_{orig} has a leading edge at 0 units and a trailing edge at 100 units, while Clk_{new} has a leading edge at 200 units and a trailing edge at 300 units, with both clocks maintaining a cycle time of 400 units. A new timing quantity for this scenario can be calculated according to the following equation:

$$New Timing Quantity = Orig Timing Quantity + ( Clknew leading edge - Clkorig leading edge )$$

where new timing quantity is the adjusted timing value for the desired clock schema 214, orig timing quantity is the original timing value for the prior clock schema 212, clknew leading edge is the leading edge time for the new clock of the desired clock schema 214, and clkorig leading edge is the leading edge time of the clock in the prior clock schema 212.

In this scenario, the transformation involves shifting the timing quantities by the difference in the leading edges of the two clocks. This shift accounts for the fact that registers launch data at different times due to the change in the leading edge. The data delay is adjusted accordingly, while the slew remains unchanged. The figure visually represents the data shift and delay adjustments used to accommodate the new leading edge timing, emphasizing the usefulness of accurately transforming constraints to ensure proper timing analysis and circuit operation under the new clock schema.

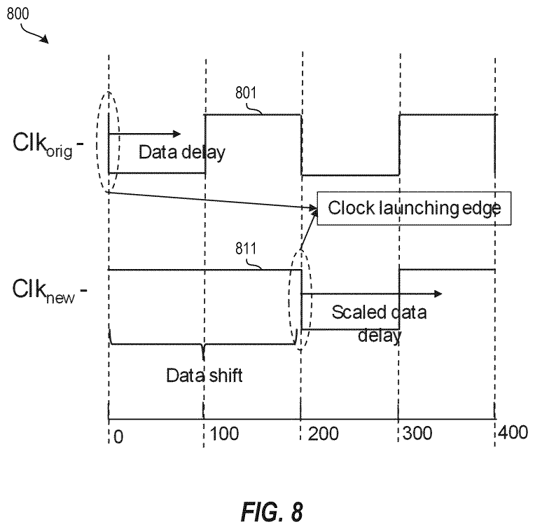

FIG. 8 illustrates a diagram of a scenario 800 for different cycle and leading edge time according to an embodiment. The scenario 800 combines changes in both cycle time and leading edge timing (e.g., a combination of scenario 600 and scenario 700). FIG. 8 shows two clock signals: clock signal 801 for Clk_{orig} and clock signal 811 for Clknew. Clkorig has a leading edge at 0 units and a trailing edge at 100 units, while Clknew has a leading edge at 200 units and a trailing edge at 300 units. Clkorig has a cycle time of 200 units, and Clknew has a cycle time of 400 units. A new timing quantity for this scenario can be calculated according to the following equation:

$$New Timing Quantity = Orig Timing Quantity * \frac{New cycle time}{Orig cycle time} + ( Clknew leading edge - Clkorig leading edge )$$

where new timing quantity is the adjusted timing value for the desired clock schema 214, orig timing quantity is the original timing value for the prior clock schema 212, new cycle time is the cycle time for the new clock of the desired clock schema 214, orig cycle time is the cycle time of the clock in the prior clock schema 212, clknew leading edge the leading edge time for the new clock of the desired clock schema 214, and clkorig leading edge is the leading edge time of the clock in the prior clock schema 212.

This scenario involves scaling the timing quantities by the ratio of the new cycle time to the original cycle time and then shifting them by the difference in leading edges. The data delay is initially scaled to account for the change in cycle time, and then a data shift is applied to adjust for the new leading edge time. This combined transformation ensures that the timing analysis remains accurate and that the circuit operates correctly under the new clock schema. The figure visually represents the adjustments in data delay and shift, highlighting the usefulness of precise constraint transformation in adapting to complex clocking changes.

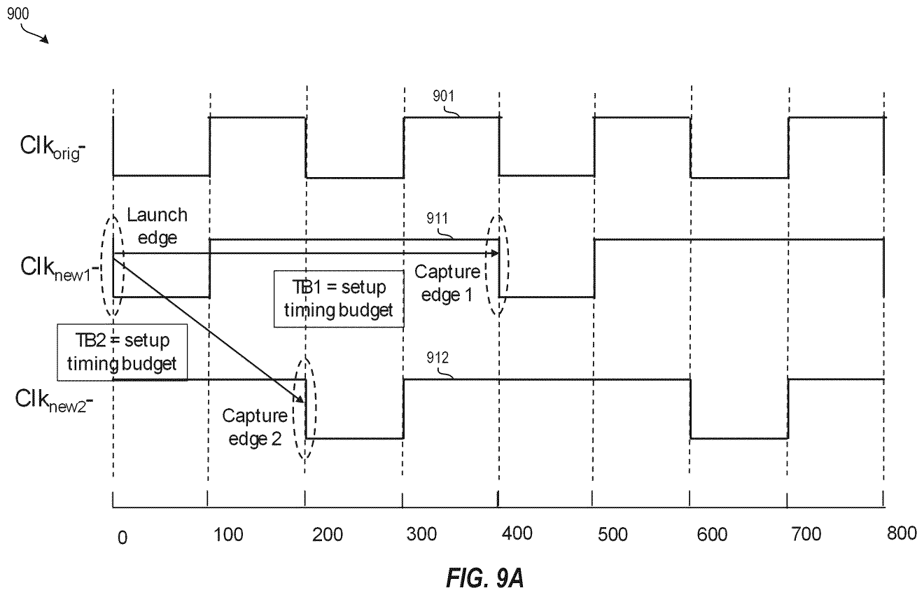

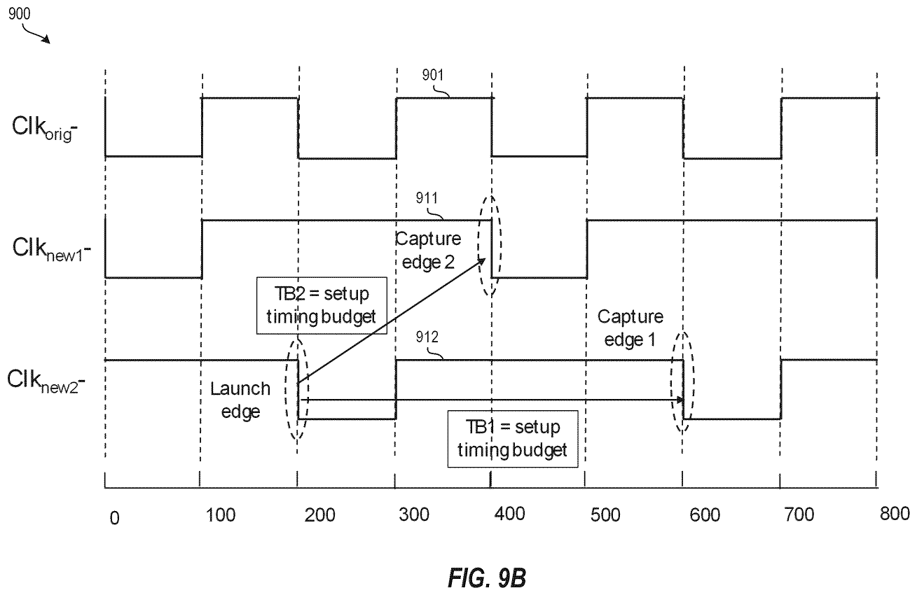

FIGS. 9A and 9B illustrates a diagram of a scenario 900 for multiple interacting clocks according to an embodiment. Transformation of one clock to multiple clocks means that each clock having its own distinct timing constraints and values of the timing constraints depend on interactions of the multiple clocks. Multiple clocks are considered interacting if data launched by any clock can be captured by all other clocks in addition to itself. The scenario 900 involves the transformation of a single clock signal into two interacting clocks. FIGS. 9A and 9B show the original clock signal 901 for Clk_{orig}, and the two new clock signals, clock signal 911 for Clk_{new1} and clock signal 912 for Clk_{new2}. Clk_{orig} has a leading edge of 0 units, a trailing edge of 100 units, and a cycle time of 200 units; Clk_{new1} has a leading edge of 0 units, a trailing edge of 100 units, and a cycle time of 400 units; and Clk_{new2} has a leading edge of 200 units, a trailing edge of 300 units, and a cycle time of 400 units. In this example scenario, data launched by Clk_{new1} leading edge can be captured by leading edge of Clk_{new1} which is the default behavior for any clock and it can also be captured by Clk_{new2} leading edge. Setup timing budget when data launched by leading edge of Clk_{new1} is captured by leading edge of Clk_{new1} is termed as TB1 and setup timing budget when data launched by leading edge of Clk_{new1} and captured by leading edge of Clk_{new2} is termed as TB2. The transformation process to compute timing constraints for Clk_{new1} uses the stricter of two setup timing budgets TB1 and TB2. A new timing quantity for this scenario can be calculated according to the following equation:

$$New Timing Quantity = Orig Timing Quantity * \frac{Setup Timing Budget}{Orig cycle time} + ( Clknew leading edge - Clkorig leading edge )$$

where new timing quantity is the adjusted timing value for the desired clock schema 214, orig timing quantity is the original timing value for the prior clock schema 212, setup timing budget is the time for a signal to propagate through the circuit and stabilize before a next clock edge triggers the captured signal and is the minimum of TB1 and TB2, orig cycle time is the cycle time of the clock in the prior clock schema 212, clknew leading edge the leading edge time for the new clock of the desired clock schema 214, and clkorig leading edge is the leading edge time of the clock in the prior clock schema 212.

The figure depicts the launch and capture events for each clock signal, highlighting how the setup timing budget is allocated between the two new clocks. Clk_{new1} and Clk_{new2} are designed to work together such that two signals propagate together instead of one (e.g., for Clk_{orig}), with their interactions ensuring that the timing requirements are met. The transformation accounts for the interactions between the clocks, ensuring that the timing analysis remains accurate and that the circuit operates correctly under the new clock schema. This scenario emphasizes the usefulness of accurately transforming constraints to accommodate multiple interacting clocks, thereby maintaining the integrity of the timing analysis and circuit functionality.

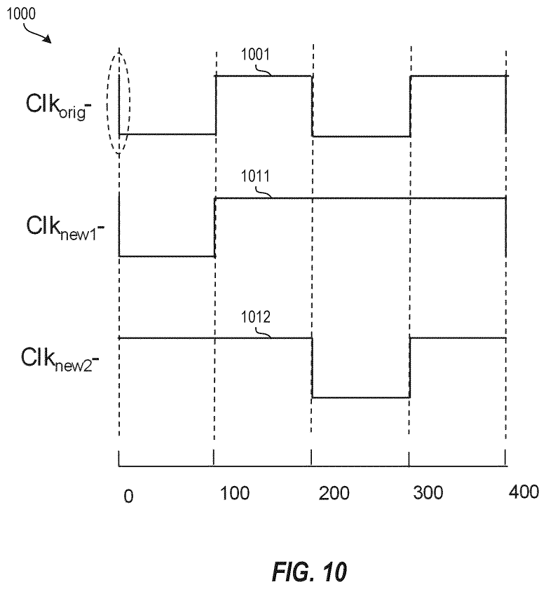

FIG. 10 illustrates a diagram of a scenario 1000 for multiple non-interacting clocks according to an embodiment. Non-interacting clocks are clock signals that operate independently (mutually exclusive) of each other, with each clock having its own distinct timing constraints and not affecting the timing of other clocks in the circuit. The scenario 1000 involves the transformation of a single clock signal into two non-interacting clock signals. FIG. 10 shows original clock signal 1001 for Clk_{orig}, and the two new clock signals, clock signal 1011 for Clk_{new1} and clock signal 1012 for Clk_{new2}. Clk_{orig} has a leading edge of 0 units, a trailing edge of 100 units, and a cycle time of 200 units; Clk_{new1} has a leading edge of 0 units, a trailing edge of 100 units, and a cycle time of 400 units; and Clk_{new2} has a leading edge of 200 units, a trailing edge of 300 units, and a cycle time of 400 units. In this scenario, the transformation process treats each new clock as if it is the only clock, applying the rules mentioned in previous scenarios independently to each clock. A new timing quantity for this scenario can be calculated according to the following equation:

$$New Timing Quantity = Orig Timing Quantity * \frac{Setup Timing Budget}{Orig cycle time} + ( Clknew leading edge - Clkorig leading edge )$$

where new timing quantity is the adjusted timing value for the desired clock schema 214, orig timing quantity is the original timing value for the prior clock schema 212, setup timing budget is the time for a signal to propagate through the circuit and stabilize before a next clock edge triggers the captured signal and assuming data is launched from leading edge and captured by leading edge setup budget for a clock will be equal to its cycle time, orig cycle time is the cycle time of the clock in the prior clock schema 212, clknew leading edge the leading edge time for the new clock of the desired clock schema 214, and clkorig leading edge is the original leading edge time of the clock in the prior clock schema 212.

FIG. 10 depicts how Clk_{new1} and Clk_{new2} each has its own distinct timing characteristics. The non-interacting nature of the clocks means that they are mutually exclusive, and their timing constraints are adapted independently. This approach ensures that the timing analysis remains accurate and that the circuit operates correctly under the new clock schema, even when the clocks do not interact with each other. The scenario highlights the usefulness of accurately transforming constraints to accommodate multiple non-interacting clocks, thereby maintaining the integrity of the timing analysis and circuit functionality.

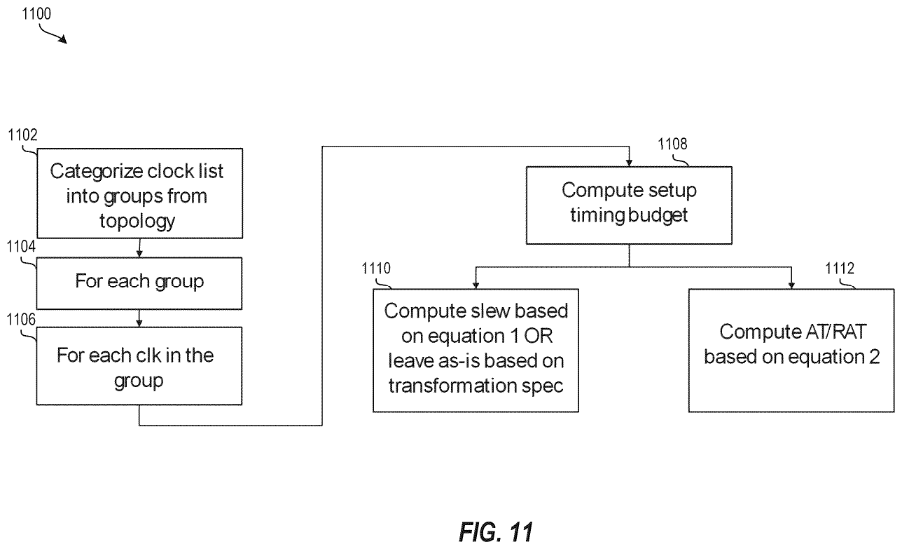

FIG. 11 illustrates a flow diagram of a method 1100 for adapting design constraints for static timing analysis of a circuit according to an embodiment. The method 1100 can be performed by any suitable computing system, device, or environment, such as those described herein. The method 1100 is now described with reference to the computing environment 100, and particularly the static timing analysis engine 150 and the design constraints adaptation engine 152, but is not so limited. That is, the method 1100 depicts operations performed by the design constraints adaptation engine 152 to adapt design constraints for static timing analysis of a circuit.

At operation 1102, the design constraints adaptation engine 152 categorizes a clock list into groups based on the topology of the design. This operation involves analyzing the design topology 218 to identify and group clocks that interact with each other. A “clock list” in the context of integrated circuit design refers to a list of the clock signals used within a particular circuit design. This list includes detailed information about the various clock signals, such as its name, frequency, phase, duty cycle, and other relevant parameters. The clock list is useful for STA and other timing verification processes, as the clock list provides an overview of the clocking scheme used in the circuit design.

At operation 1104, the design constraints adaptation engine 152 begins an iterative process for each group of the clock list.

At operation 1106, for each clock in the group, the design constraints adaptation engine 152 begins another iterative process of computing a setup timing budget (operation 1108), computing a slew (operation 1110), and computing AT and RAT values (operation 1112).

At operation 1108, the design constraints adaptation engine 152 computes a setup timing budget. This operation involves determining the timing budget available for each group of clocks in the clock list to ensure proper timing analysis and circuit operation. A “timing budget” in the context of integrated circuit design refers to the allocation of time for various stages of signal propagation within a circuit to ensure that the overall timing requirements are met. A timing budget is an aspect of STA and aids in verifying that signals propagate through the circuit within acceptable time limits (e.g., within the timing budget), ensuring the circuit operates correctly, efficiently, and reliably.

At operation 1110, the design constraints adaptation engine 152 leaves the slew as-is based on the transformation specification or computes the slew based on the following equation (referred to as “equation 1”):

$$New Timing Quantity = Orig Timing Quantity * \frac{Setup Timing Budget}{Orig cycle time} .$$

This operation involves calculating the slew rate, which is the rate of change of the signal at the clock input, using the prior equation. New timing quantity is the adjusted timing value for the desired clock schema 214, orig timing quantity is the original timing value for the prior clock schema 212, setup timing budget is the total time allocated for the setup of a signal, including setup time, propagation delay, and any clock skew, and orig cycle time is the original cycle time of the clock in the prior clock schema 212.

At operation 1112, the design constraints adaptation engine 152 computes the AT and RAT using the following equation (referred to as “equation 2”):

$$New Timing Quantity = Orig Timing Quantity * \frac{Setup Timing Budget}{Orig cycle time} + ( Clknew leading edge - Clkorig leading edge )$$

This operation involves determining the time at which the signal arrives at the primary input (AT) and the time by which the signal must arrive at the primary output (RAT) to meet the timing requirements using the prior equation. New timing quantity is the adjusted timing value for the desired clock schema 214, orig timing quantity is the original timing value for the prior clock schema 212, setup timing budget is the total time allocated for the setup of a signal, including setup time, propagation delay, and any clock skew, orig cycle time is the original cycle time of the clock in the prior clock schema 212, Clknew leading edge is the leading edge time of the clock in the desired clock schema 214, and Clk_{orig} leading edge is the leading edge time of the clock in the prior clock schema 212.

Additional processes also may be included, and it should be understood that the processes depicted in FIG. 11 represent illustrations, and that other processes may be added or existing processes may be removed, modified, or rearranged without departing from the scope of the present disclosure. It should also be understood that the processes depicted in FIG. 11 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

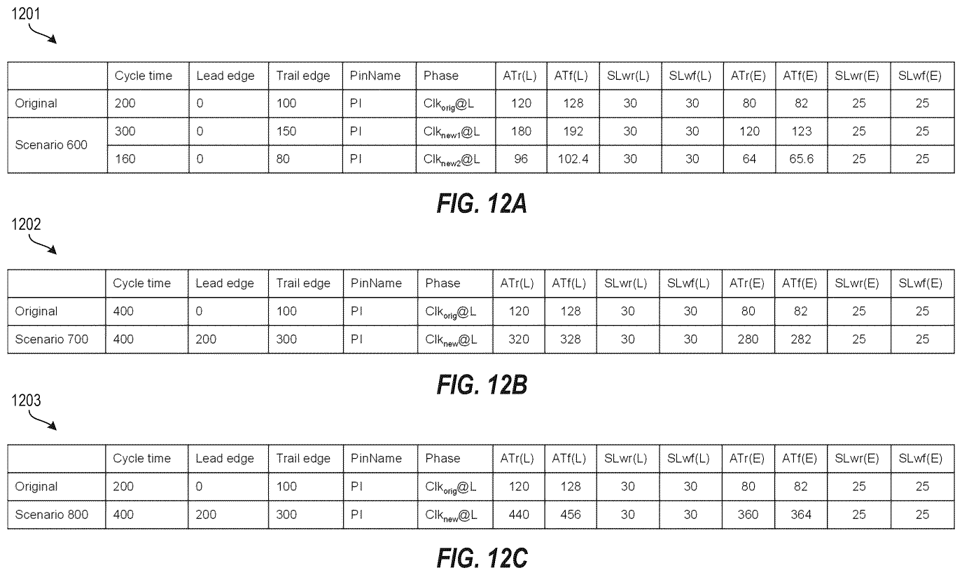

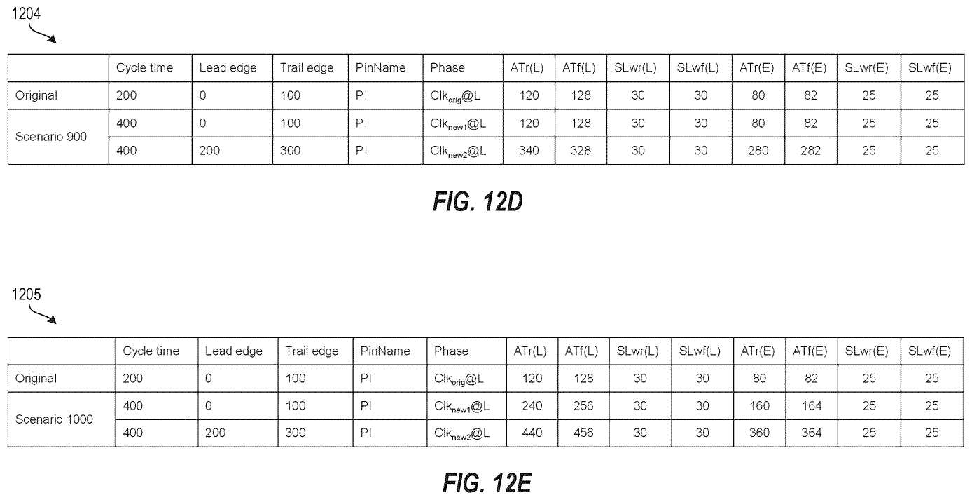

FIGS. 12A-12E illustrate examples of tables of adapting design constraints for static timing analysis of a circuit according to various embodiments. In particular, FIG. 12A illustrates a table 1201 of design constraints for static timing analysis of a circuit based on the scenario 600 of FIG. 6. FIG. 12B illustrates a table 1202 of design constraints for static timing analysis of a circuit based on the scenario 700 of FIG. 7. FIG. 12C illustrates a table 1203 of design constraints for static timing analysis of a circuit based on the scenario 800 of FIG. 8. FIG. 12D illustrates a table 1204 of design constraints for static timing analysis of a circuit based on the scenario 900 of FIGS. 9A and 9B. FIG. 12E illustrates a table 1205 of design constraints for static timing analysis of a circuit based on the scenario 1000 of FIG. 10.

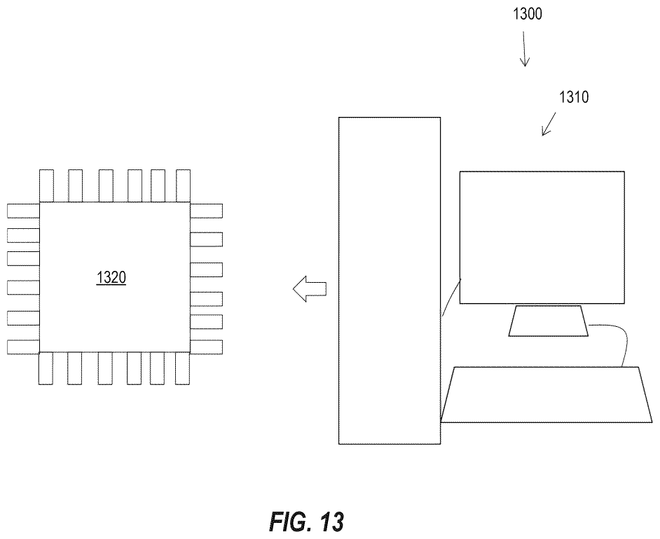

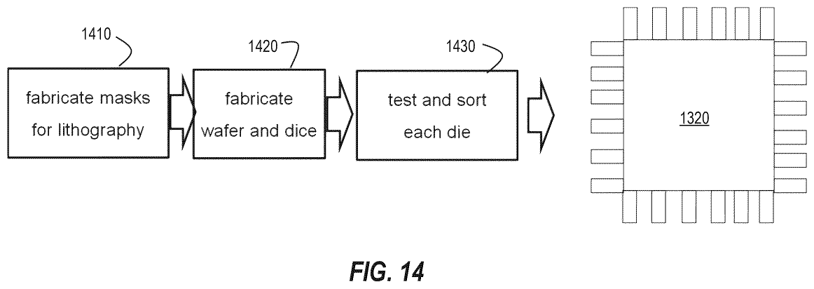

FIG. 13 is a block diagram of a system 1300 to perform circuit design optimization according to one or more embodiments. The system 1300 includes processing circuitry 1310 used to generate the circuit design that is ultimately fabricated into an integrated circuit 1320. The steps involved in the fabrication of the integrated circuit 1320 are well-known and briefly described herein. Once the physical layout is finalized, based, in part, on the circuit design optimization according to one or more embodiments, the finalized physical layout is provided to a foundry. Masks are generated for each layer of the integrated circuit based on the finalized physical layout. Then, the wafer is processed in the sequence of the mask order. The processing includes photolithography and etch. This is further discussed with reference to FIG. 14.

Particularly, FIG. 14 is a flow diagram of a method 1400 of fabricating an integrated circuit according to one or more embodiments. Once the physical design data is obtained, based, in part, on performing circuit design optimization as described herein, the integrated circuit 1320 can be fabricated according to known processes that are generally described with reference to FIG. 14. Generally, a wafer with multiple copies of the final design is fabricated and cut (i.e., diced) such that each die is one copy of the integrated circuit 1320. At block 1410, the processes include fabricating masks for lithography based on the finalized physical layout. At block 1420, fabricating the wafer includes using the masks to perform photolithography and etching. Once the wafer is diced, testing and sorting each die is performed, at block 1430, to filter out any faulty die.

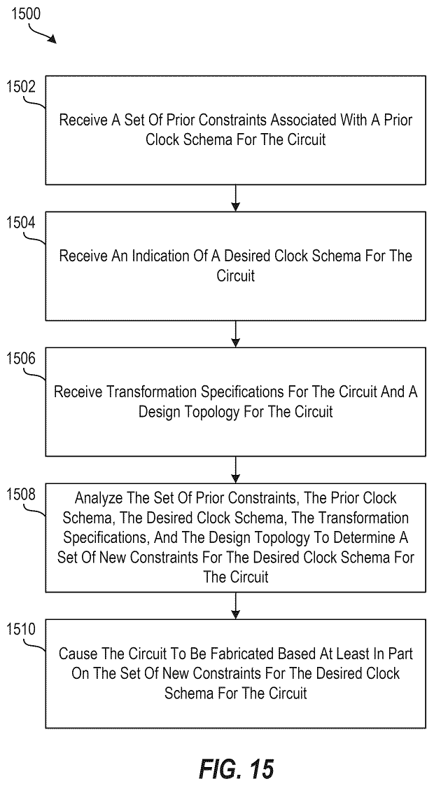

FIG. 15 illustrates a flow diagram of a method 1500 for adapting design constraints for static timing analysis of a circuit according to an embodiment. The method 1500 can be performed by any suitable computing system, device, or environment, such as those described herein. The method 1500 is now described with reference to the computing environment 100, and particularly the static timing analysis engine 150 and the design constraints adaptation engine 152, but is not so limited. That is, the method 1500 depicts operations performed by the design constraints adaptation engine 152 to adapt design constraints for static timing analysis of a circuit.

Operation 1502 involves receiving a set of prior constraints (e.g., prior constraints 210) associated with a prior clock schema (e.g., prior clock schema 212) for the circuit (e.g., circuit 300). Operation 1504 entails receiving an indication of a desired clock schema (e.g., desired clock schema 214) for the circuit. In Operation 1506, transformation specifications (e.g., transformation specifications 216) for the circuit and a design topology (e.g., design topology 218) for the circuit are received. Operation 1508 includes analyzing the set of prior constraints, the prior clock schema, the desired clock schema, the transformation specifications, and the design topology to determine a set of new constraints (e.g., new constraints 204) for the new clock schema for the circuit. This can be accomplished, for example, as described with reference to the scenarios depicted in FIGS. 6-10. Finally, Operation 1510 involves causing the circuit to be fabricated based at least in part on the set of new constraints for the new clock schema for the circuit. This can be accomplished, for example, as described with reference to FIGS. 13 and 14.

Additional processes also may be included, and it should be understood that the processes depicted in FIG. 15 represent illustrations, and that other processes may be added or existing processes may be removed, modified, or rearranged without departing from the scope of the present disclosure. It should also be understood that the processes depicted in FIG. 15 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein significantly enhance static timing analysis by automating the adaptation of design constraints when transitioning between different clock schemas or PVT conditions. This automation reduces the potential for error in the circuit design and transitioning process and increases efficiency, ensuring that the new design constraints are optimized for the specific requirements of the new circuit design. By using static methods to account for variations in process, voltage, and temperature, one or more embodiments provide a more accurate distribution of potential timing outcomes, rather than relying on a single worst-case scenario. This leads to improved circuit functionality, as the circuits are better equipped to meet desired speed requirements and operate reliably under various conditions. The automated process also allows for the seamless conversion of single-edge clocking circuits to dual-edge clocking circuits, further enhancing the circuit's performance by utilizing both rising and falling edges for data transfer. Additionally, the functionality of the computer implementing such embodiments is improved through the use of a design constraints adaptation engine, which efficiently processes inputs, such as prior constraints, clock schemas, and transformation specifications, to generate new, optimized constraints. This not only streamlines the design process but also ensures that the computer system can handle complex clocking techniques and adapt constraints across different PVT corners, ultimately leading to more robust and reliable circuit designs.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for adapting design constraints for static timing analysis of a circuit, the method comprising:
receiving a set of prior constraints associated with a prior clock schema for the circuit;
receiving an indication of a desired clock schema for the circuit;
receiving transformation specifications for the circuit and a design topology for the circuit;
analyzing the set of prior constraints, the prior clock schema, the desired clock schema, the transformation specifications, and the design topology to determine a set of new constraints for the desired clock schema for the circuit; and
causing the circuit to be fabricated based at least in part on the set of new constraints for the desired clock schema for the circuit.

2. The computer-implemented method of claim 1, wherein a new cycle time of the desired clock schema differs from a prior cycle time of the prior clock schema.

3. The computer-implemented method of claim 1, wherein a new leading edge of the desired clock schema differs from a prior leading edge of the prior clock schema.

4. The computer-implemented method of claim 1, wherein a new cycle time of the desired clock schema differs from a prior cycle time of the prior clock schema, and wherein a new leading edge of the desired clock schema differs from a prior leading edge of the prior clock schema.

5. The computer-implemented method of claim 1, wherein the desired clock schema implements two interacting clocks.

6. The computer-implemented method of claim 1, wherein the desired clock schema implements two non-interacting clocks.

7. The computer-implemented method of claim 1, wherein determining the set of new constraints for the desired clock schema for the circuit comprises transforming the set of prior constraints from a single-edge clocking circuit to a dual-edge clocking circuit.

8. The computer-implemented method of claim 1, wherein determining the set of new constraints for the desired clock schema for the circuit comprises transforming the set of prior constraints from one process, voltage, and temperature (PVT) sensor to another PVT sensor.

9. A computer system comprising:
a processor set;
one or more computer-readable storage media; and
program instructions stored on the one or more computer-readable storage media to cause the processor set to perform operations comprising:
receiving a set of prior constraints associated with a prior clock schema for the circuit;
receiving an indication of a desired clock schema for the circuit;
receiving transformation specifications for the circuit and a design topology for the circuit;
analyzing the set of prior constraints, the prior clock schema, the desired clock schema, the transformation specifications, and the design topology to determine a set of new constraints for the desired clock schema for the circuit; and
causing the circuit to be fabricated based at least in part on the set of new constraints for the desired clock schema for the circuit.

10. The computing system of claim 9, wherein a new cycle time of the desired clock schema differs from a prior cycle time of the prior clock schema.

11. The computing system of claim 9, wherein a new leading edge of the desired clock schema differs from a prior leading edge of the prior clock schema.

12. The computing system of claim 9, wherein a new cycle time of the desired clock schema differs from a prior cycle time of the prior clock schema, and wherein a new leading edge of the desired clock schema differs from a prior leading edge of the prior clock schema.

13. The computing system of claim 9, wherein the desired clock schema implements two interacting clocks.

14. The computing system of claim 9, wherein the desired clock schema implements two non-interacting clocks.

15. The computing system of claim 9, wherein determining the set of new constraints for the desired clock schema for the circuit comprises transforming the set of prior constraints from a single-edge clocking circuit to a dual-edge clocking circuit.

16. The computing system of claim 9, wherein determining the set of new constraints for the desired clock schema for the circuit comprises transforming the set of prior constraints from one process, voltage, and temperature (PVT) sensor to another PVT sensor.

17. A computer program product comprising:
one or more computer-readable storage media; and
program instructions stored on the one or more computer-readable storage media to perform operations comprising:
receiving a set of prior constraints associated with a prior clock schema for the circuit;
receiving an indication of a desired clock schema for the circuit;
receiving transformation specifications for the circuit and a design topology for the circuit;
analyzing the set of prior constraints, the prior clock schema, the desired clock schema, the transformation specifications, and the design topology to determine a set of new constraints for the desired clock schema for the circuit; and
causing the circuit to be fabricated based at least in part on the set of new constraints for the desired clock schema for the circuit.

18. The computer program product of claim 17, wherein a new cycle time of the desired clock schema differs from a prior cycle time of the prior clock schema.

19. The computer program product of claim 17, wherein a new leading edge of the desired clock schema differs from a prior leading edge of the prior clock schema.

20. The computer program product of claim 17, wherein a new cycle time of the desired clock schema differs from a prior cycle time of the prior clock schema, and wherein a new leading edge of the desired clock schema differs from a prior leading edge of the prior clock schema.
